(19) United States
(12) Patent Application Publication
(10) Pub. No.: US 2015/0096225 A1
(43) Pub. Date: Apr. 9, 2015

(54) MINI GREENHOUSE HAVING AN AUTOMATED TEMPERATURE CONTROL

(71) Applicant: Ronald GERVAIS, St-Bruno (CA)

(72) Inventor: Ronald GERVAIS, St-Bruno (CA)

(21) Appl. No.: 14/045,839

(22) Filed: Oct. 4, 2013

(51) Int. Cl. A01G 9/16

(52) U.S. Cl. CPC A01G 9/16
USPC 47/17

(57) ABSTRACT

A greenhouse comprises a body, a lid, an actuator, a temperature sensor and a controller. The body has a front wall, a back wall and two opposite lateral walls. The actuator is connected to the body and is in contact with the lid. The temperature sensor is connected to the controller and is located so as to read a temperature inside the body. The controller is electrically connected to the actuator and is electrically connected to the sensor so as to receive a temperature signal from the sensor. The controller is both operative to activate the actuator so as to open the lid when the temperature sensor reads a first temperature inside the body and to activate the actuator so as to close the lid when the temperature sensor reads a second temperature inside the body.

### FIELD OF THE INVENTION

The present invention generally relates to the field of greenhouses. More specifically, the invention relates to a mini greenhouse designed for home use and adequate for starting seedlings, the greenhouse having an automated temperature control capable of controlling the greenhouse temperature within a certain range.

### BACKGROUND OF THE INVENTION

Mini greenhouses for home use, used primarily for starting seedlings, consist typically of a translucent enclosure having a openable access door to reach the seedlings. These small greenhouses, with their rather basic design, work adequately in tempered climates. They however are less than adequate in climates having or creating larger temperature variation within a short period of time. For example, in northern climates such as in Canada, a cold sunny day of winter may create inside such mini greenhouses cold temperatures when the sun is absent but warm temperatures when the sun is present. In this case, the typical mini greenhouse is inadequate for growing seedlings.

Larger, industrial greenhouses have some kind of temperature and humidity regulation system, but these are far too complex and expensive for use with a simple and affordable mini greenhouse.

There is therefore a need for a simple, affordable mini greenhouse capable of providing adequate results in colder climates.

### SUMMARY OF THE INVENTION

It is an object of the present invention to provide a greenhouse that overcomes or mitigates one or more disadvantages of known greenhouses, or at least provides a useful alternative.

Advantageously, the present invention provides a greenhouse that works adequately in colder climates by controlling the greenhouse temperature within a certain range.

In accordance with an embodiment of the present invention, there is provided a greenhouse comprising a body, a lid, an actuator, a temperature sensor and a controller. The body has a front wall, a back wall and two opposite lateral walls. The actuator is connected to the body and is in contact with the lid. The temperature sensor is connected to the controller and is located so as to read a temperature inside the body. The controller is electrically connected to the actuator and is electrically connected to the sensor so as to receive a temperature signal from the sensor. The controller is both operative to activate the actuator so as to open the lid when the temperature sensor reads a first temperature inside the body and to activate the actuator so as to close the lid when the temperature sensor reads a second temperature inside the body.

Optionally, the greenhouse further comprises a heating mat. The heating mat is adapted to fit inside the body proximate a lower portion of the body. The controller is connected to the heating mat and is further operative to activate the heating mat when the temperature sensor reads a third temperature inside the body. The first temperature is higher than the second temperature and the second temperature is higher than the third temperature. For example, the first temperature is substantially 30 degrees Celcius (86 degrees Farenheit), the second temperature is substantially 20 degrees Celcius (68 degrees Farenheit) and the third temperature is substantially 15 degrees Celcius (59 degrees Farenheit).

Preferably, the back wall of the body is taller than the front wall so that the lid is inclined downwardly towards the front wall. The lid is hinged proximate the front wall, or simply to front wall, so as to open predominantly at the back wall.

Preferably, each one of the front wall, the two opposite lateral walls and the lid have a plurality of edges and a middle panel. The middle panel is made of a rigid translucent plastic such as a sheet of twin-wall polycarbonate while the plurality of edges are made of heartwood, and most preferably larch heartwood.

Optionally, the back wall may be white on an interior side of the body so as to reflect light. A geotextile membrane may also be used under the heating mat to prevent weeds from growing inside the greenhouse and to discourage insects from entering the greenhouse.

Alternatively, the temperature sensor and the controller may be combined in a first thermostat. The greenhouse then also comprises a second thermostat that is operative to activate the heating mat when the thermostat reads the third temperature inside the body.

Optionally, the actuator may be a linear actuator.

Preferably, the lid rests freely on the actuator so that the lid is free so as to be easily lifted by hand.

Preferably, the body of the greenhouse measures less than 60 inches in length.

The greenhouse may be provided without a bottom so as to be installed directly on the ground.

### BRIEF DESCRIPTION OF DRAWINGS

These and other features of the present invention will become more apparent from the following description in which reference is made to the appended drawings wherein:

FIG. 1 is an isometric view from the front and left of a greenhouse with its lid dosed in accordance with an embodiment of the present invention;

FIG. 2 is an isometric view from the front and right of the greenhouse of FIG. 1 with its lid open;

FIG. 3 is an isometric view of the greenhouse of FIG. 1 with its lid fully open;

FIG. 4 is a flowchart of the control logic of the controller of the greenhouse of FIG. 1 in accordance with an embodiment of the invention;

FIG. 5 is an isometric view of the greenhouse in accordance with another embodiment of the present invention.

FIG. 6a is a wiring diagram of the electrical circuit of the greenhouse in accordance with another embodiment of the present invention.

FIG. 6b is a wiring diagram of the electrical circuit of the greenhouse in accordance with another embodiment of the present invention.

### DETAILED DESCRIPTION OF THE INVENTION

The present invention relates to a greenhouse designed for home use and adequate for containing small seedlings boxes. The greenhouse is designed for colder climates. Advantageously, the greenhouse is equipped with an automated temperature control capable of controlling the greenhouse temperature within a certain range.

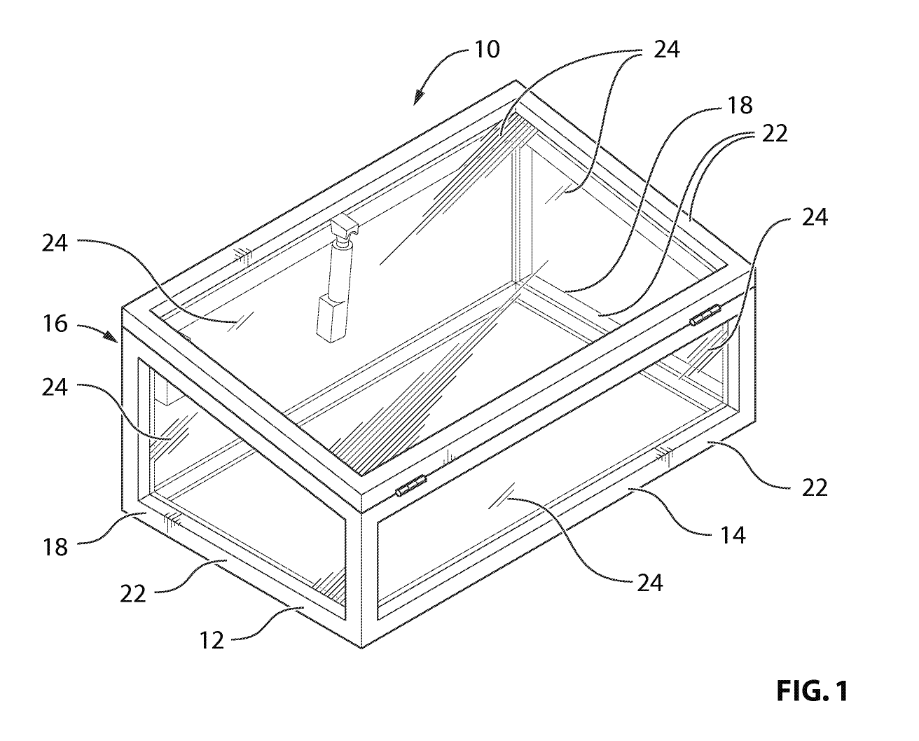

FIG. 1 is now referred to. A greenhouse 10 comprises a body 12 which has a front wall 14, a back wall 16 and two opposite lateral walls 18. The greenhouse also comprises an openable lid 20. Each one of the front wall 14, the two opposite lateral walls 18 and the lid 20 are made of an outer frame 22 and a middle panel 24. The outer frames 22 may be made of many suitable materials, such as plastic, aluminum or wood, but are preferably made of heartwood, and more preferably larch heartwood. Larch heartwood is the hardest of all the softwoods and is especially suited to make greenhouses as it contains natural chemicals which are toxic to decay-causing fungi and insects. It resists water penetration, wear, and indentation, and can last decades with little maintenance. The middle panel 24 is made of a translucent material. It has been found that a translucent rigid plastic such as a sheet of twin-wall polycarbonate performs very well and is very durable. The back wall 16, which has an outer frame 22 similar to that of the front wall 14 or of the lateral walls 18, preferably uses an opaque middle panel 26. This opaque middle panel 26 may be white or mirror on the interior side of the greenhouse 10 so as to reflect light towards the interior. It may be noticed that the back wall 16 is taller than the front wall 14 so that the lid 20 is inclined downwardly towards the front wall 14. This allows for rain water to drain naturally towards the front of the greenhouse 10. Because the greenhouse 10 is intended for home use, its body 12 preferably measures less than 60 inches in length although any convenient size could be manufactured.

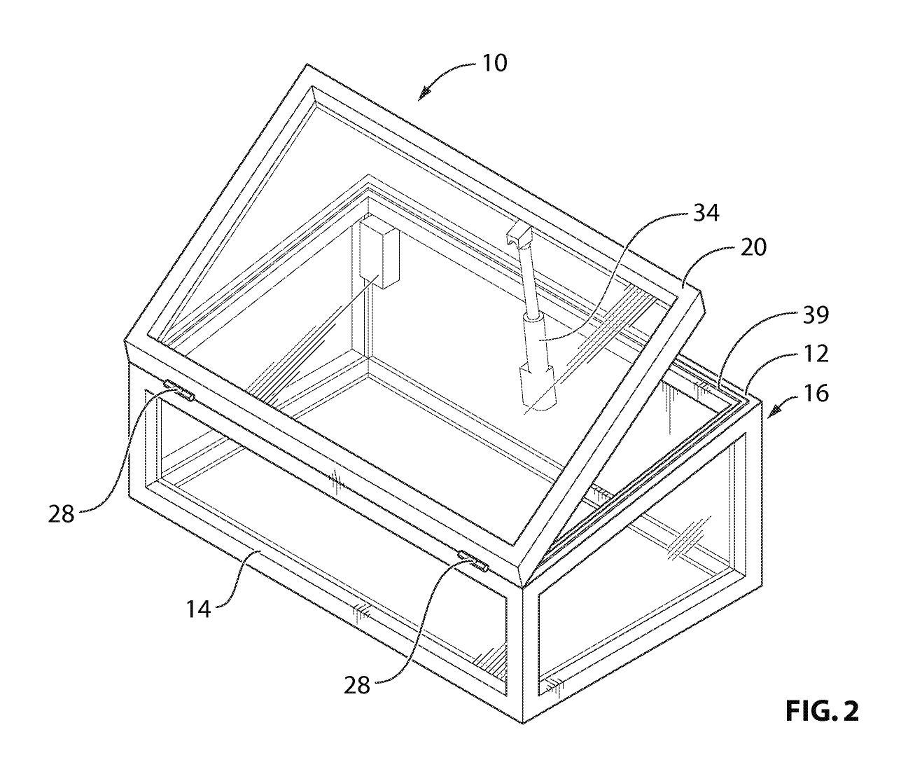

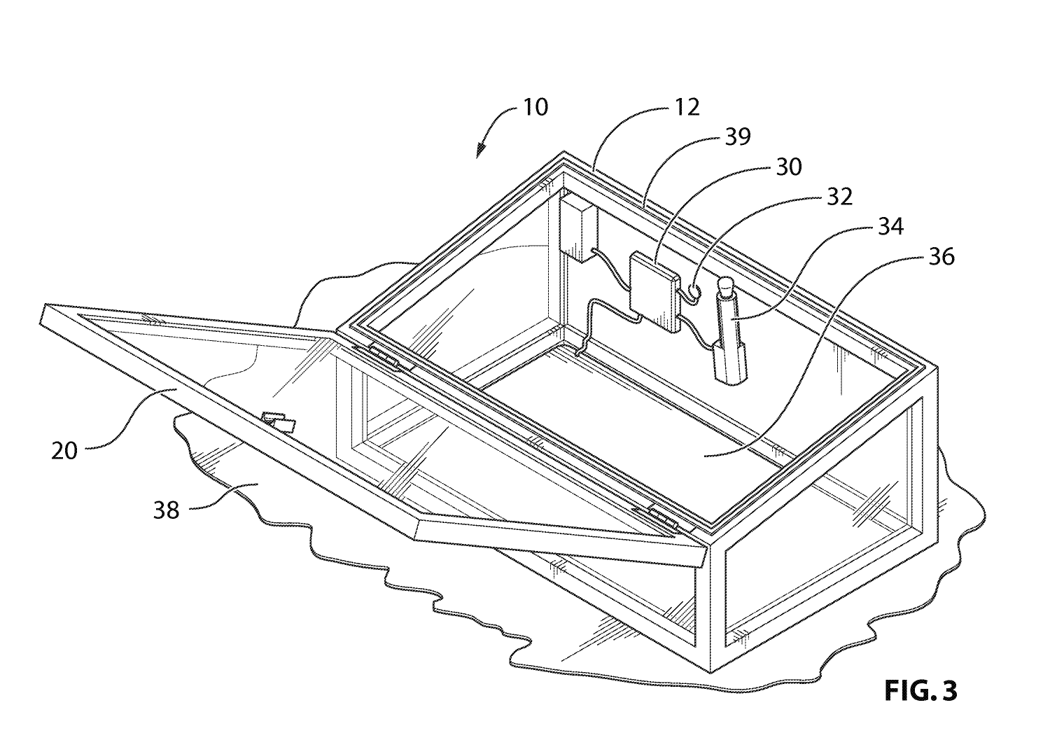

FIGS. 2 and 3 are now concurrently referred to. The lid 20 is preferably hinged proximate its front portion, such as at the front wall 14, so as to open predominantly at the back wall 16. Because cold air is denser than warm air, warm air accumulates closer to the higher region of the interior of the greenhouse 10. To evacuate heat more easily, it is therefore preferable to let air flow out the interior of the greenhouse 10 towards the back. Any type of convenient hinging mechanism, such as piano hinges 28, may be used.

Although not shown in the figures, the lid 20 may use, if necessary, one or more stiffeners organized in ways to prevent the middle panel 24 from sagging. For example such a stiffener could run lengthwise or widthwise in a center of the lid 20.

The greenhouse 10 is also equipped with a controller 30, a temperature sensor 32 and an actuator 34. The temperature sensor 32, which is connected to the controller 30, is located inside the greenhouse 10 so as to read a temperature inside the body 12. As shown, the temperature sensor 32 is placed on the back wall 16, but could conveniently be placed in any other adequate place within the greenhouse 10. The temperature sensor 32 is operative to send to the controller 30 a temperature signal representative of the interior temperature of the greenhouse 10.

The actuator 34 is also electrically connected to the controller 30. The actuator 34 is installed on the body 12 and is operative to contact the lid 20. As presented, the actuator 34 is an electrical linear actuator, which comprises an extendable rod 36. However, as would be apparent to a person skilled in the art, many other types of actuators could be used. As shown in FIG. 3, the lid 20 rests freely on the actuator 34 so that it may be lifted freely by hand to access the interior of the greenhouse 10, for example for watering plants being grown inside the greenhouse 10. FIG. 1 depicts the lid 10 in a closed position. In this case the lid 20 rest against the body 12. This position is used when it is desired to keep heat inside the greenhouse 10. FIG. 2 depicts the lid 10 in an open position. The open position of the lid 10 is used whenever it is desired to let heat escape from the greenhouse 10. In this case, the actuator 34 pushes against the lid 20 to lift it.

The greenhouse 10 also comprises a heating mat 36. The heating mat 36 is adapted to fit inside the body 12 at a lower portion of the body 12. The heating mat 36 constitutes the bottom of the greenhouse 10 as the body 12 does not extend underneath the heating mat 36. In this sense, the body 12 is bottomless and in use, the lower portions of the body 12 rest directly on the ground. However, advantageously, a geotextile membrane 38 may be placed under the greenhouse 10 and the heating mat 36 in order to prevent weeds from growing inside the greenhouse 10, allow water drainage and to discourage insects from entering the greenhouse 10. This is best shown in FIG. 2.

The greenhouse 10 may further comprise a weather strip 39 between the lid 20 and the top portion of the body 12 to help preventing heat from escaping the interior of the greenhouse 10 when the lid 20 is closed. The weather strip 39 may be placed either on the lid 20 or the body 12. As shown in FIG. 3, the weather strip 39 is placed on the body 12.

Electrical power for powering the controller 30 and the actuator 34 typically come from the grid and the voltage may be lowered to a required voltage by a transformer 40. Transformers and their use are well known by those skilled in the art.

The greenhouse 10 of the present invention is designed for a typical use in regions with colder climates. Indeed, in these regions, nights are typically cold, but as the sun comes out in the morning, temperatures rise steadily so as to even become too warm inside the greenhouse 10.

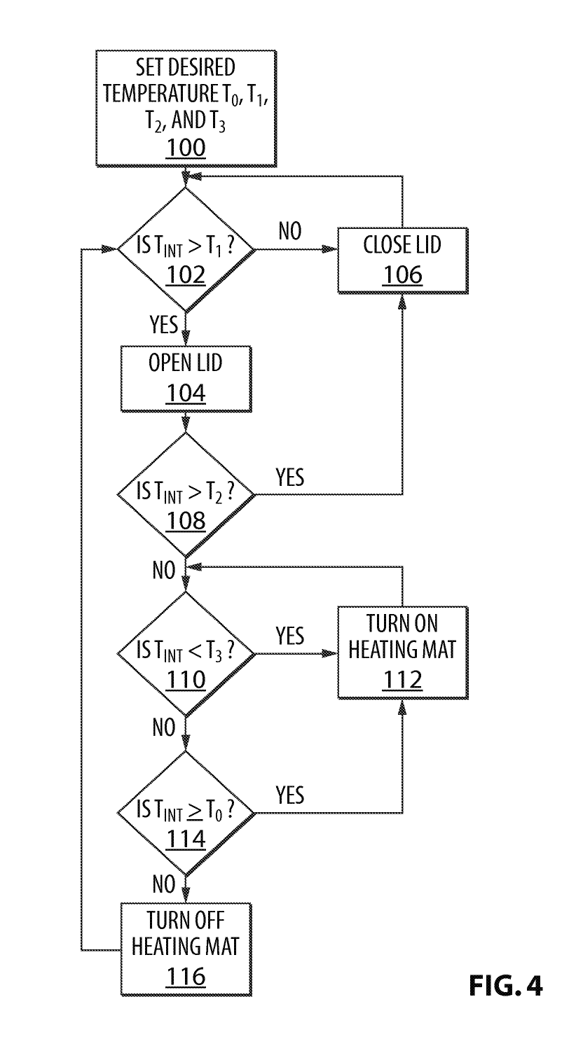

FIG. 4 is now referred to. In use, the lid 20 is typically closed over the body 12 so as to keep the interior of the greenhouse 10 at a desired interior temperature T₀. At step 100, temperatures T₀, T₁, T₂ and T₃ are set. Temperature T₀ may typically be set at 25° Celcius (77° Farenheit). As the exterior temperature increases, it is likely that the interior temperature increases too. If the temperature sensor 32 reads that the interior temperature exceeds a predetermined threshold temperature T₁ at step 102, where T₁ is higher than T₀, the controller 30 is operative to activate the actuator 34 and open the lid 20 at step 104 so as to let some heat escape from the interior of the greenhouse 10. For example, T₁ may be set at 30° Celcius (86° Farenheit). Otherwise, the lid 20 is kept closed at step 106. As the exterior temperature decreases, for instance at sundown, it is likely that the interior temperature will also go down. When the temperature sensor 32 takes a second reading of the temperature inside the greenhouse 10 and that this temperature reading is lower than a second predetermined threshold temperature T₂, then the controller 30 is operative to activate the actuator 34 at step 108 so as to dose the lid 20. Typically, T₂ may be set at 20° Celcius (68° Farenheit). Closing the lid will prevent heat from escaping easily the greenhouse 10. Once the lid 20 has been opened, it does not get dosed before the interior temperature decreases below T₂ at step 106.

Once the lid 20 has been dosed, it could occur that the temperature sensor 32 detects an interior temperature that is even lower than T₂. For example, exterior temperatures could drop even more during the night. When the temperature sensor 32 detects that the interior temperature is lower than a third predetermined threshold temperature T₃ at step 110, it sends a signal to the controller 30 which then activates the heating mat 36 in order to heat the interior of the greenhouse 10 at step 112. For example, T₃ could be set at 10° Celcius (50° Farenheit). Once the temperature sensor 32 detects that the interior temperature has reached at least T₀ (or any other pre-set temperature, such as 15° Celcius (59° Farenheit) for example) at step 114, the controller 30 then turns off the heating mat 36. Otherwise, the heating mat is kept turned on at step 116.

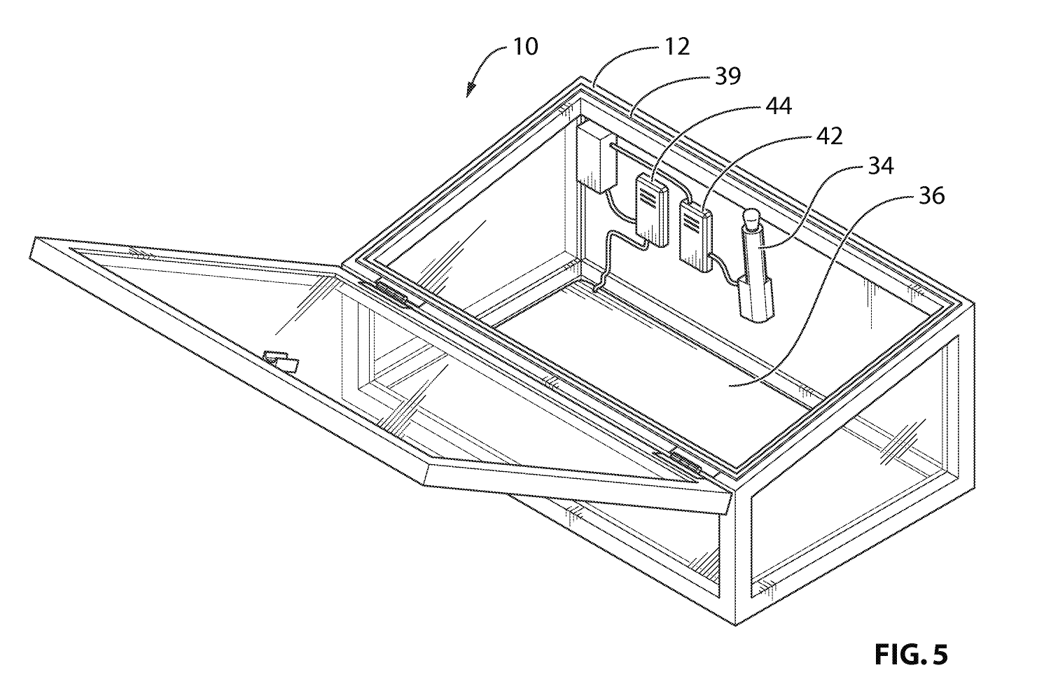

FIG. 5 is now referred to and represents a second embodiment of the present invention. Alternatively, the temperature sensor 32 and the controller 30 could be combined in a first thermostat 42 and in a second thermostat 44. The combination of the first thermostat 42 and the second thermostat 44 function similarly as previously described, with the exception that the first thermostat 42 controls the actuator 34 while the second thermostat 44 controls the heating mat 36. The first thermostat 42 may be of a type so as to have two predetermined threshold temperatures T₁ and T₂, while the second thermostat 44 may be of the type and has the single predetermined temperature T₃. Both the first and second thermostats 42, 44 may be a mechanical, hydraulic, bi-metal or liquid thermostat. For example, the first thermostat 42 may be of the hydraulic type while the second thermostat 44 may be of the bi-metal type. Because of the inherent accuracy differential (hysteresis) of these thermostats, the first and second thermostats 42, 44 may be set at a predetermined threshold temperature median those of the on/off condition. For example, for thermostats having a hysteresis of 3 degrees, the first thermostat 42 could be set at 25° Celcius (77° Farenheit) and it will naturally switch on the actuator 34 at 28° Celcius (82° Farenheit) to open the lid 20 and switch off the actuator 24 at 22° Celcius (72° Farenheit) so as to dose the lid 20. Similarly, the second thermostat 44 could be set at 17° Celcius (63° Farenheit) so as to switch on the heating mat 36 at 14° Celcius (57° Farenheit) and switch off the heating mat 36 at 20° Celcius (68° Farenheit). Any of the predetermined temperatures T₀, T₁, T₂ or T₃ may either be set by the manufacturer or by the end user.

Whether the temperature variation of the interior of the greenhouse described occur with one or the other of the embodiments described above, it has been found that this temperature variation is beneficial to the hardiness of the plants.

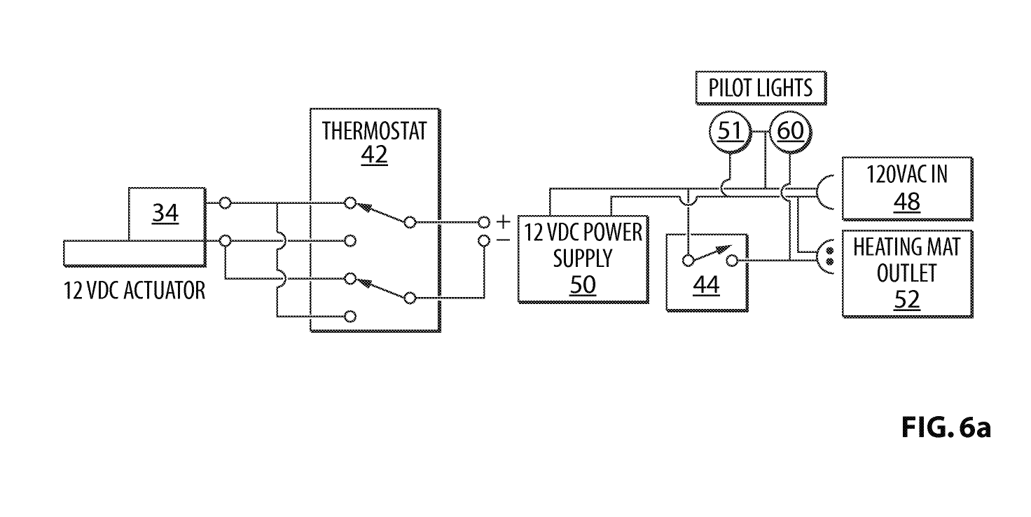

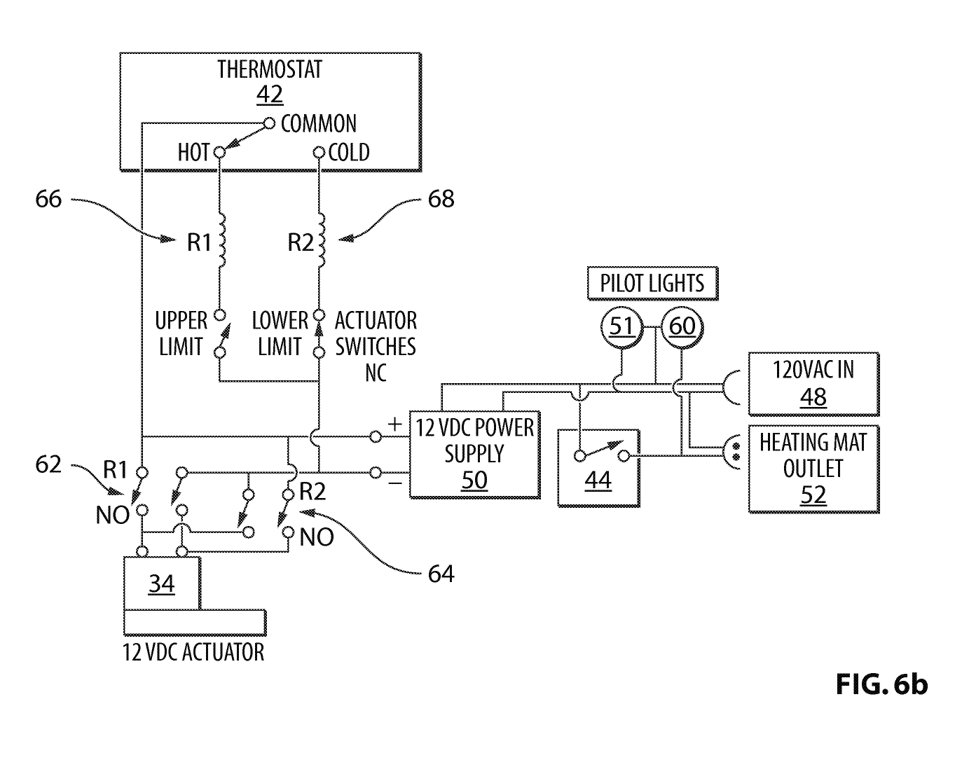

FIGS. 6a and 6b, now referred to, represents examples of wiring diagrams of the electrical connections of some components previously described. The electrical components may be placed within a weather proof enclosure. A 12 VDC power supply 50 is connected to a 120 VAC power inlet 48. A green pilot light 51 indicates when the power is turned on. The first thermostat 42 is connected to the power supply 50 and to the actuator 34. The actuator 34 may comprise a 12 VDC motor and a gearbox. FIG. 6a represents a schematic where the first thermostat 42 is a DPDT thermostat. FIG. 6b represents a schematic where the first thermostat 42 is a SPOT thermostat. In this case, the first thermostat 42 is adapted to activate two DPST relays 62 and 64 by controlling their respective coils 66 and 68. The two DPST relays 58 are used to allow reversing the polarity of the DC to the actuator 34 so that it may retract. The relays 62, 64 are energized when there is a temperature change and the motor of the actuator 34 is activated. They are then de-energized when the actuator 34 reaches its limit switch. The heating mat 36 (not shown) is connected to a heating mat outlet 60. The second thermostat 44 is directly connected to the 120 VAC power inlet 48 and is also connected to the heating mat outlet 52. A red pilot light 60 indicates that the heating mat 36 is turned on.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description. The invention is defined by the claims that follow.

I claim:

1. A greenhouse comprising:
a body, said body having a front wall, a back wall and two opposite lateral walls;
a lid;
an actuator, said actuator being connected to said body and being in contact with said lid and;
a temperature sensor, said temperature sensor being connected to said controller, said temperature sensor being located so as to read a temperature inside said body;
a controller, said controller being connected to said actuator, said controller being electrically connected to said temperature sensor so as to receive a temperature signal from said temperature sensor,
wherein said controller is operative to activate said actuator so as to open said lid when said temperature sensor reads a first temperature inside said body, said controller being operative to activate said actuator so as to close said lid when said temperature sensor reads a second temperature inside said body.

2. The greenhouse of claim 1 further comprising a heating mat, said heating mat being adapted to fit inside said body proximate a lower portion of said body, said controller being connected to said heating mat, said controller being further operative to activate said heating mat when said temperature sensor reads a third temperature inside said body.

3. The greenhouse of claim 2 wherein said back wall is taller than said front wall so that said lid is inclined downwardly towards said front wall, said lid being hinged proximate said front wall so as to open predominantly at said back wall.

4. The greenhouse of claim 2 wherein said first temperature is higher than said second temperature and wherein said second temperature is higher than said third temperature.

5. The greenhouse of claim 4 wherein said first temperature is substantially 30° Celcius (86° Farenheit) and said second temperature is substantially 29° Celcius (68° Farenheit).

6. The greenhouse of claim 5 wherein said third temperature is substantially 15° Celcius (59° Farenheit).

7. The greenhouse of claim 1 wherein each one of said front wall, said two opposite lateral walls and said lid have a plurality of edges and a middle panel, said middle panel being made of a rigid translucent plastic.

8. The greenhouse of claim 7 wherein said back wall is white on an interior side of said body.

9. The greenhouse of claim 7 where each one of said middle panels is made of a sheet of twin-wall polycarbonate.

10. The greenhouse of claim 7 wherein said plurality of edges are made of larch heartwood.

11. The greenhouse of claim 1 wherein said temperature sensor and said controller are combined in a first thermostat.

12. The greenhouse of claim 11 further comprising a second thermostat, said second thermostat being operative to activate said heating mat when said thermostat reads a third temperature inside said body.

13. The greenhouse of claim 1 wherein said actuator is a linear actuator.

14. The greenhouse of claim 1 wherein said lid rests freely on said actuator so that said lid is free for being lifted by hand.

15. The greenhouse of claim 1 wherein said body measures less than 60 inches in length.

16. The greenhouse of claim 1 further comprising a geotextile membrane under said heating mat.

17. The greenhouse of claim 1 wherein said body is bottomless.

18. The greenhouse of claim 1 further comprising a weather strip between said body and said lid.
